(19) United States
(12) Patent Application Publication
(10) Pub. No.: US 2016/0221178 A1
(43) Pub. Date: Aug. 4, 2016

(54) MAGNETIC TOOL SUSPENSION RACK

(71) Applicant: Chih-Chien Hsieh, Taichung (TW)

(72) Inventor: Chih-Chien Hsieh, Taichung (TW)

(21) Appl. No.: 14/613,929

(22) Filed: Feb. 4, 2015

(51) Int. Cl. B25H 3/04; F16M 13/02

(52) U.S. Cl. CPC B25H 3/04; F16M 13/022

(57) ABSTRACT

A magnetic tool suspension rack in accordance with the present invention comprises a rack having at least one groove longitudinally defined in a bottom thereof, wherein the at least one groove having the function of limiting. Multiple tool holders are slidably mounted on a top of the rack, wherein the tool holders are adapted to collect hand tools. At least one magnetic device is slidably mounted in the at least one groove, wherein at least one magnetic is limited within the groove and is adapted for positioning the rack with hand tools on a adsorbate.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a tool suspension rack, and more particularly to a magnetic suspension rack for hand-held tools. relates to sprinkling head, and more particularly to a sprinkling head of a percussive sprinkler.

2. Description of Related Art Including Information Disclosed Under 37 CFR 1.97 and 37 CFR 1.98

A conventional elongated tool suspension rack is usually hung on a wall, on a belt or hand-held. However, the suspension rack is inconvenient for a user to take and hang the suspension rack when the suspension rack is positioned on the wall. In addition, the suspension rack is heavy when being suspended on the belt with hand-held tools, and the suspension rack cannot be positioned during operating when it is a hand-held type. Consequently, some magnetic tool suspension racks are manufactured and marketed.

However, the conventional magnetic tool suspension rack in accordance with the prior art usually includes a rack and multiple magnetic device received in a groove defined in a bottom of the rack and each magnetic device has a seat provided for receiving a magnet. However, the seat of a conventional magnetic device has a width smaller than that of the groove. As a result, each seat needs two holders to position two opposite ends of the seat of the magnetic device for preventing the magnetic device from detaching from the rack. Consequently, the seat of the magnetic device and the holder must be accurately manufactured because the seat of the magnetic device and the holders must abut against one another and cannot be moved relative to one another. The magnetic device may detach from the rack when the holder is moved relative to the seat and separated from the seat of the magnetic device. In addition, the magnet of the conventional magnetic device directly abuts a cabinet such that the magnet may detach from the seat of the magnetic device when the magnetic effect between the magnet and the cabinet is greater than that between the magnet and the seat of the magnetic device after the rack is detached from the cabinet.

The present invention has arisen to mitigate and/or obviate the disadvantages of the conventional magnetic tool suspension rack.

### BRIEF SUMMARY OF THE INVENTION

The main objective of the present invention is to provide an improved magnetic tool suspension rack that is position by at least one magnetic device mounted in a bottom thereof.

To achieve the objective, the magnetic tool suspension rack in accordance with the present invention comprises a rack having at least one groove longitudinally defined in a bottom thereof, wherein the at least one groove having the function of limiting. Multiple tool holders are slidably mounted on a top of the rack, wherein the tool holders are adapted to collect hand tools. At least one magnetic device is slidably mounted in the at least one groove, wherein at least one magnetic is limited within the groove and is adapted for positioning the rack with hand tools on a adsorbate.

The magnetic device is limited in the groove in the bottom of the rack by the structure thereof. Consequently, the magnetic tool suspension rack in accordance with the present invention provides no structure to prevent the magnetic device from detaching from the rack for providing a simplified structure and manufacturing processes.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a perspective view of a magnetic tool suspension rack in accordance with the present invention;

FIG. 2 is an exploded perspective view of the magnetic tool suspension rack in FIG. 1;

FIG. 3 is a bottom plan view of the magnetic tool suspension rack in FIG. 1;

FIG. 4 is an exploded perspective view of a second embodiment of the magnetic tool suspension rack in accordance with the present invention;

FIG. 5 is a bottom plan view of the second embodiment of the magnetic tool suspension rack in accordance with the present invention;

FIG. 6 is a bottom plan view of a magnetic device of the second embodiment of the magnetic tool suspension rack in accordance with the present invention;

FIG. 7 is a cross-sectional view of the second embodiment of the magnetic tool suspension rack along line 7-7 in FIG. 5;

FIG. 8 is a cross-sectional view of the second embodiment of the magnetic tool suspension rack along line 8-8 in FIG. 5;

FIG. 9 is a partially enlarged view of FIG. 7;

FIG. 10 is a cross-sectional view of a second embodiment of the magnetic tool suspension rack in accordance with the present invention;

FIG. 11 is a perspective view of a fourth embodiment of the magnetic tool suspension rack in accordance with the present invention;

FIG. 12 is a cross-sectional view of a fifth embodiment of the magnetic tool suspension rack in accordance with the present invention; and

FIG. 13 is side plan view of the fifth embodiment of the magnetic tool suspension rack in accordance with the present invention.

### DETAILED DESCRIPTION OF THE INVENTION

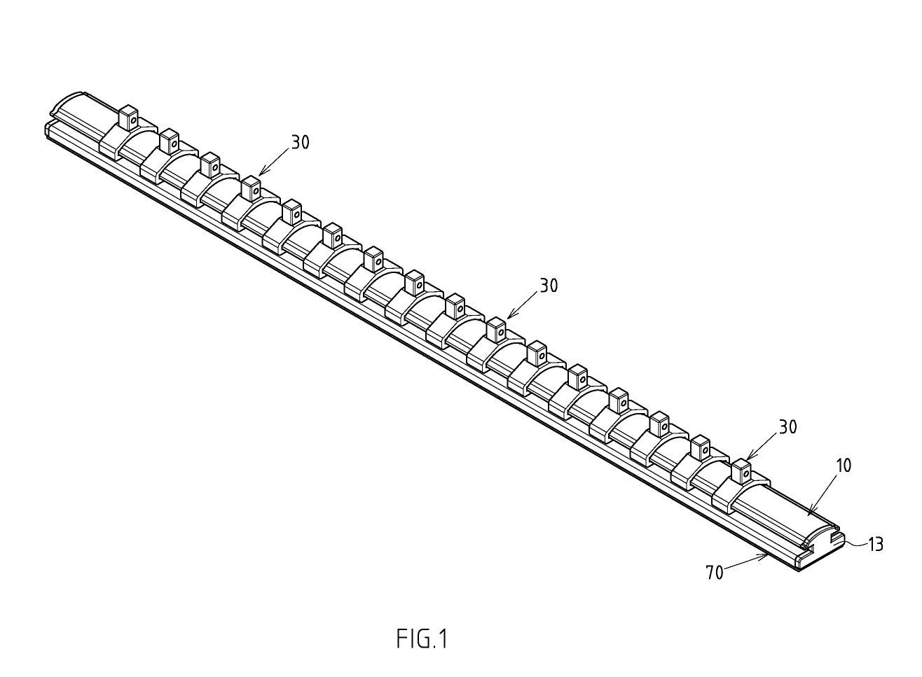

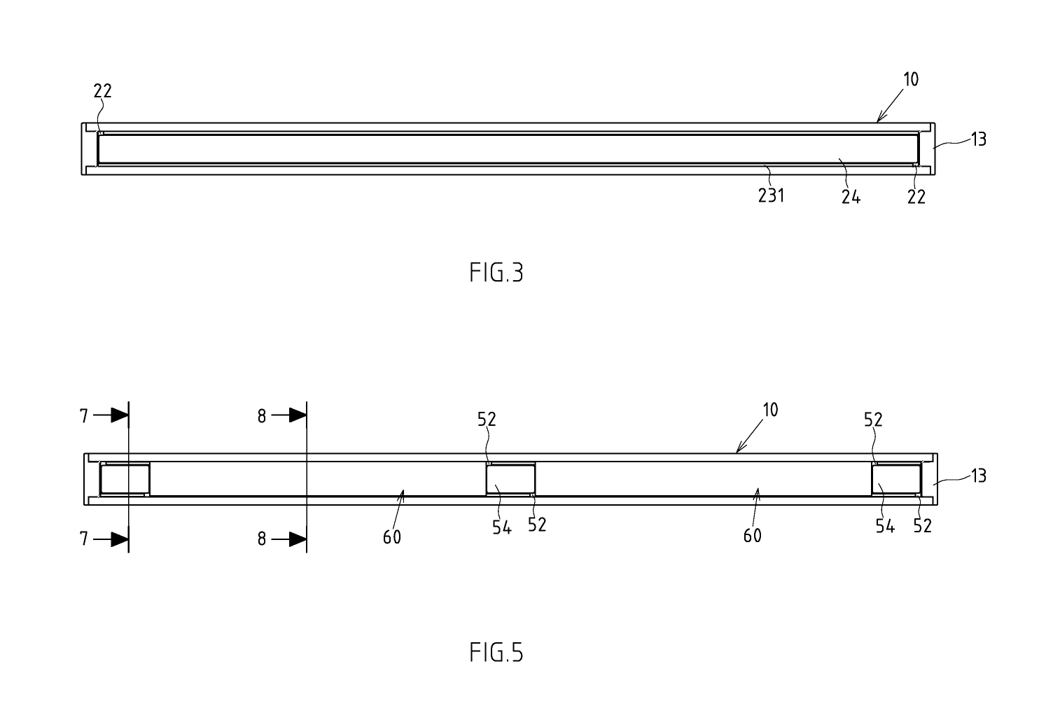

Referring to the drawings and initially to FIGS. 1-3, a magnetic tool suspension rack in accordance with the present invention comprises rack 10, at least one magnetic device 20 slidably mounted in the bottom of the rack 10 and multiple tool holders 30 slidably mounted on the top of the rack 10, wherein each tool holder 30 is adapted to hold a hand tool 40 in place. By the at least one magnetic device 20, the rack 10 with the positioned hand tools 40 can be positioned on a magnetic cabinet (not shown) for orderly collecting hand tools 40 in a work site or on a display rack (not shown) for orderly showing the hand tools 40.

Further with reference to FIGS. 7 and 9, the rack 10 includes a groove 11 longitudinally defined in a bottom thereof, wherein the groove 11 has a T-shaped cross-section for providing a limiting function to the magnetic device 20. A first slide structure 12 is longitudinally formed on a top of the rack 10, wherein the first slide structure 12 has a T-shaped cross-section. The magnetic device 20 includes a seat 21 slidably received in the groove 11, wherein the seat 21 is made of magnetic induction material and has two engagers 22 respectively extending from two opposite sides of the seat 21. Each engager 22 is laterally received in a corresponding one of two opposite sides of the groove 11 to prevent the seat 21 from detaching from the rack 10. In the preferred embodiment of the present invention, the two engagers 22 are respectively from two opposite ends of a diagonal line of the seat 21. The seat 21 has a trough 23 defined therein and a magnet 24 is received in the trough 23. The trough 23 has a depth greater than a thickness of the magnet 24 such that a height difference H is formed between a sidewall 231 of the trough 23 and the face of the magnet 24. The height difference H can prevent the magnet 24 from directly abutting the adsorbate (cabinet or display rack). In addition, the two opposite sides of the magnet 24 has the best magnetic effect and the two sidewalls 231 of the trough 23 respectively and directly abuts to a corresponding one of the two opposite sides of the magnet 24 such that the distal edge of each of the two sidewalls 231 of the trough 23 can enhance the magnetic effect between the magnetic device 20 and the adsorbate. Each end of the rack 10 has an end-piece 13 mounted thereon to prevent the magnetic device 20 from longitudinally detaching from the rack 10.

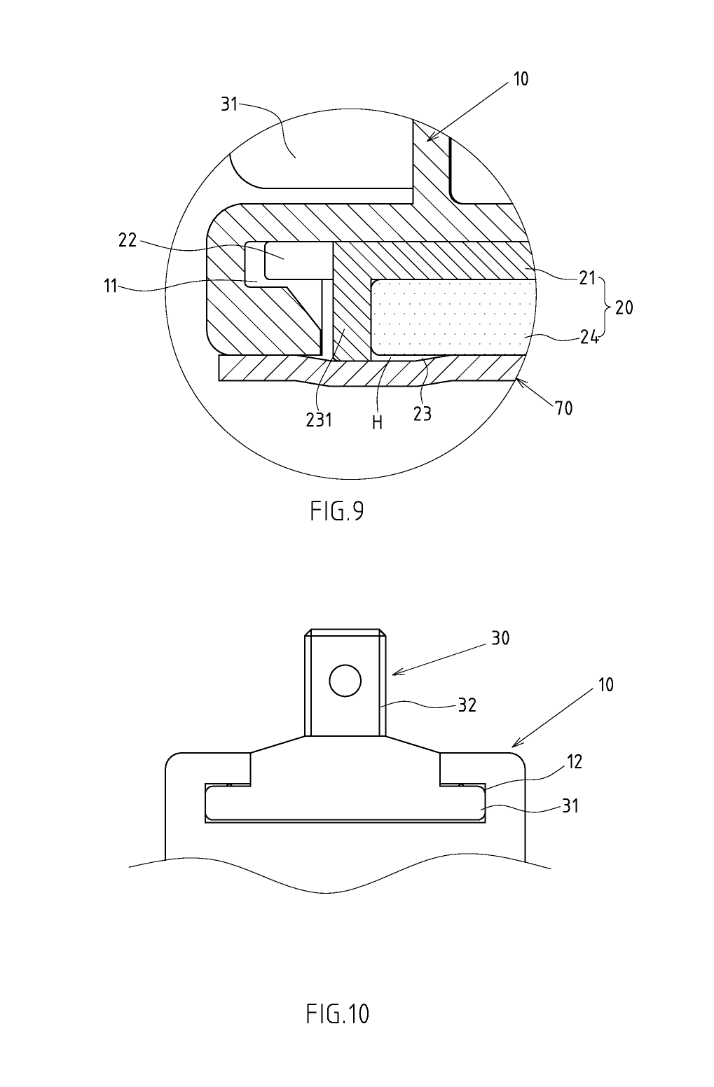

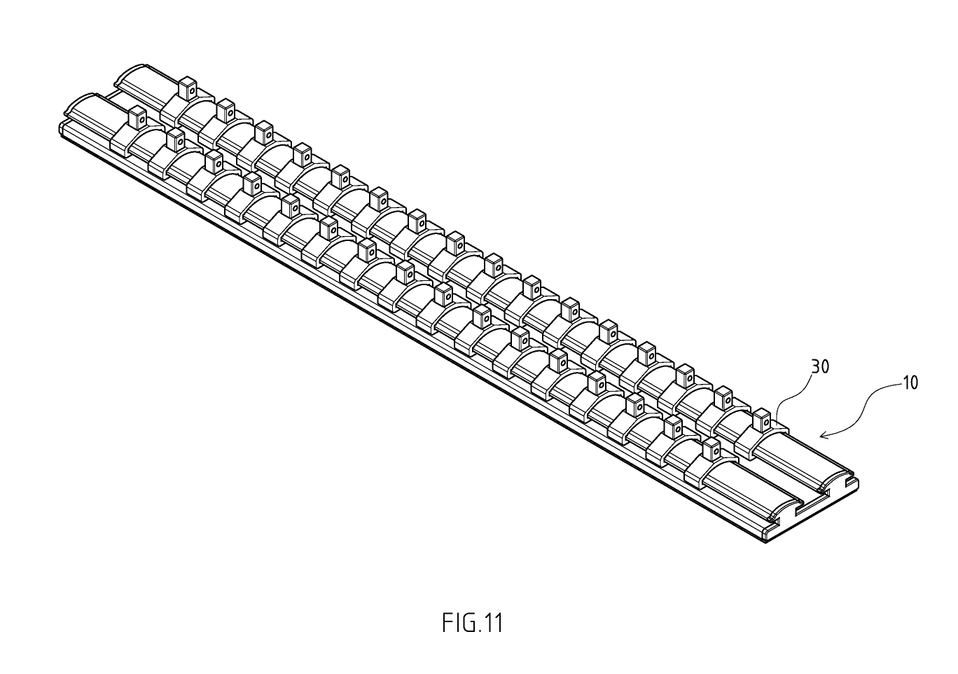

The tool holder 30 includes a second slide structure 31 formed on a bottom of the tool holder 30 and a stub 32 extending from a top of the tool holder 30, wherein the second slide structure 31 complementally corresponds to the first slide structure 12 and the stub 32 is adapted to be inserted into the hand tool 40. With reference to FIG. 7, the first slide structure 12 is a rail and the second slide structure 31 is a groove. With reference to FIG. 10, the first slide structure 12 is a groove and the second slide structure 31 is a rail.

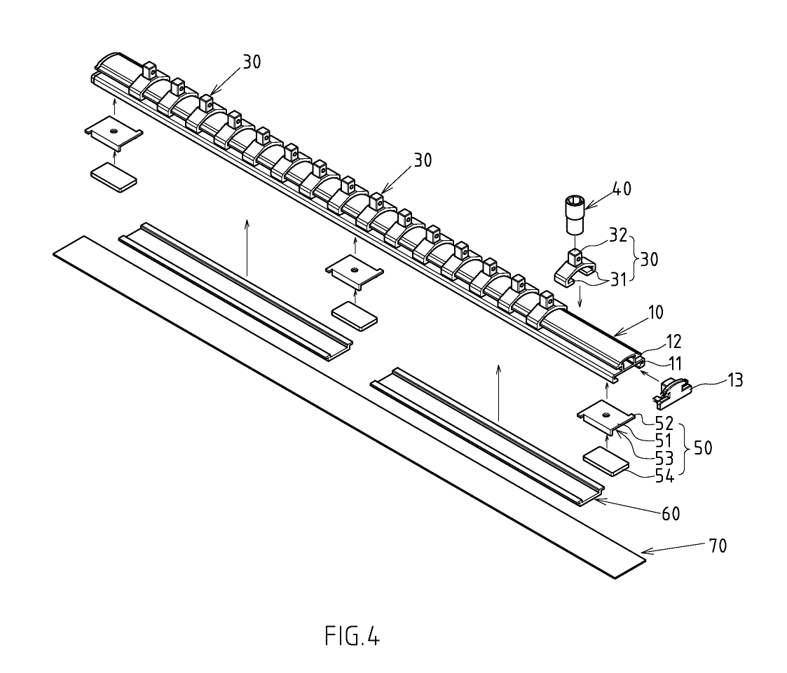

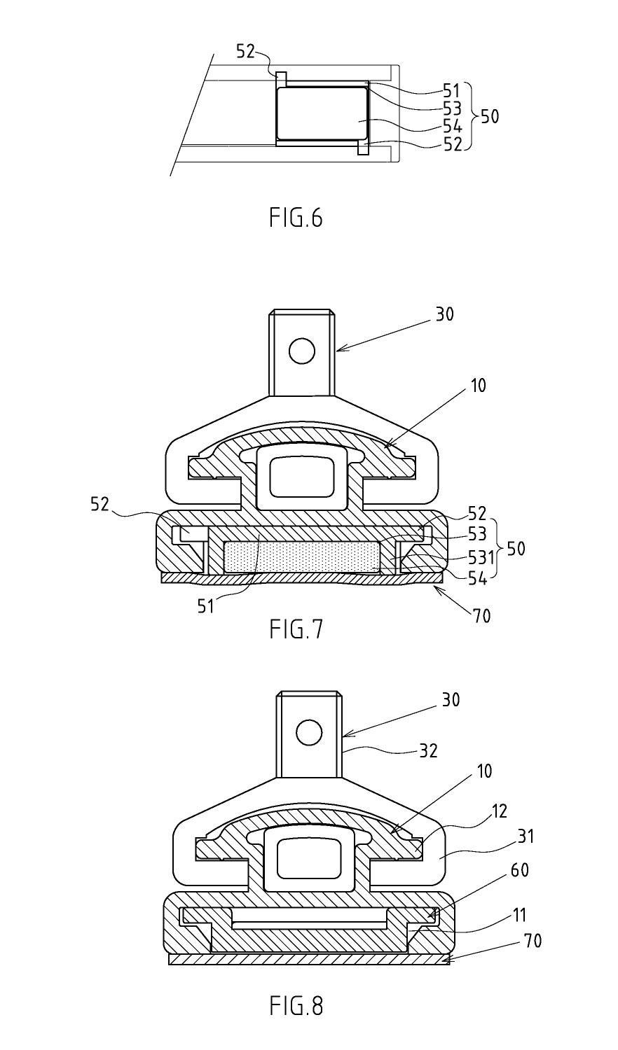

With reference to FIGS. 4 to 8 that show a second embodiment of the present invention, the structures of the rack 10 and the tool holder 30 are the same as that of the first embodiment, hereinbefore. In this embodiment, there are multiple magnetic devices 50 slidably received in the groove 11. Each magnetic device 50 includes a seat 51 made of magnetic induction material and a magnet 54 received in the seat 51. The magnetic device 50 has a total length shorter than that of the magnetic device 10 of the first embodiment, as described above. However, the magnetic device 50 has a structure similar to that of the magnetic device 10 of the first embodiment. The seat 51 of the magnetic device 50 has two engagers 52 extending therefrom and laterally received in a corresponding one of two opposite sides of the groove 11 in the rack 10. A trough 53 is defined in the seat 51 for receiving a magnet 54. In this embodiment, the total length of the magnetic device 50 is greatly shortened relative to the magnetic device 20 of the first embodiment such that the magnetic devices 50 can be freely moved relative to the rack 10. Consequently, the rack 10 with the positioned hand tool 40 can be moved relative to the adsorbate when the magnetic devices 50 are positioned on the adsorbate. Accordingly, the magnetic device 50 also can be positioned in the groove 11 in the bottom of the rack 10. The magnetic tool suspension rack in accordance with the present further includes a stopper 60 slidably received in the groove 11 between every two adjacent magnetic devices 50 to limit the moving distance of the magnetic devices 50 or hold the magnetic devices 50 in place. As shown in FIG. 5, the magnetic devices 50 are positioned in the groove 11 in the bottom of the rack 10. In addition, the magnetic tool suspension rack in accordance with the present further includes a pad 70 secured on the bottom of the rack 10 for closing the groove 11 and preventing the seat 21/51 from scratching the outer periphery of the adsorbate.

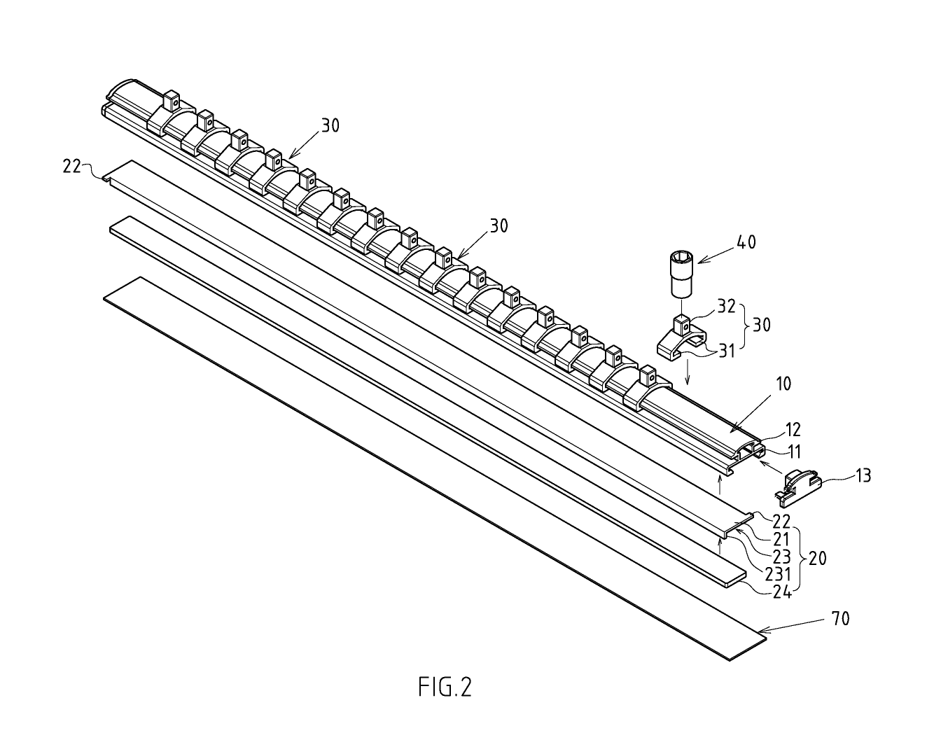

With reference to FIG. 11 that shows a fourth embodiment of the magnetic tool suspension rack in accordance with the present invention, in this embodiment, there are two racks 10 of the first/second embodiment, as shown in FIG. 2/3, laterally and integrally connected to each other for mounting more tool holders 30 and positioning more hand tools 40.

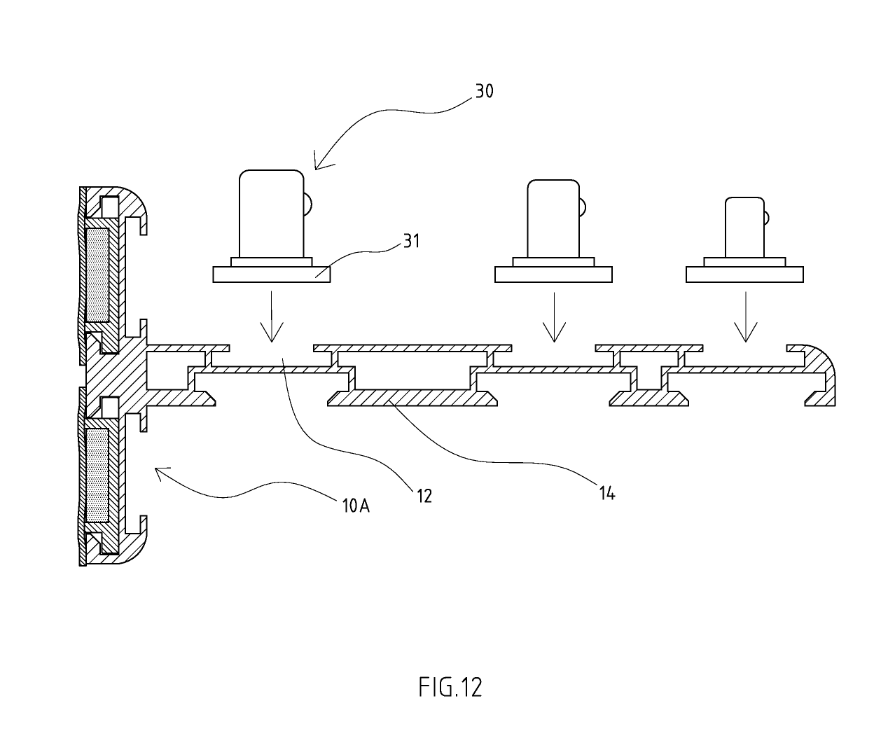

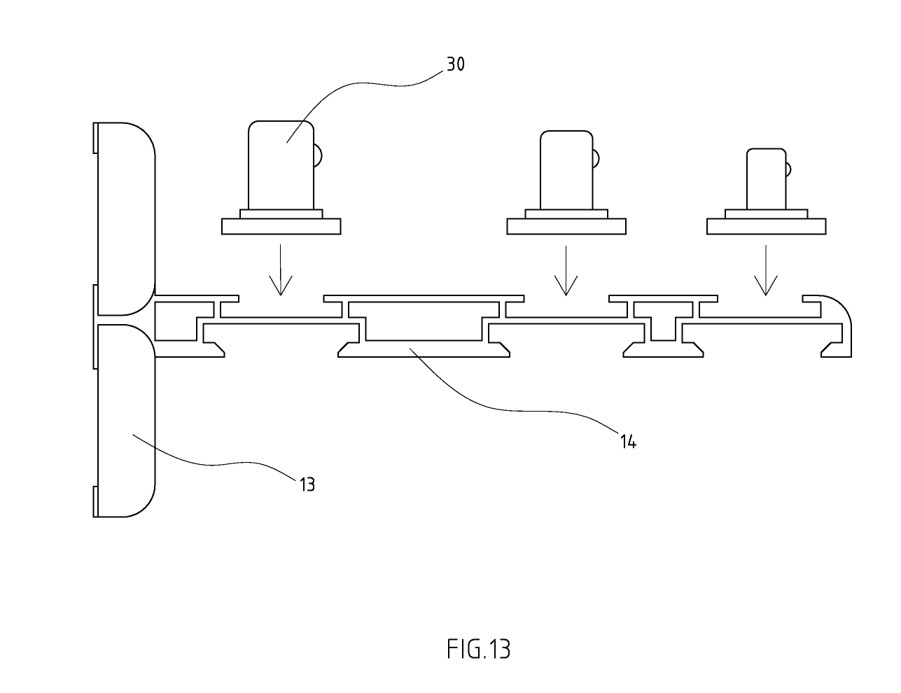

With reference to FIGS. 12 and 13 that shown a fifth embodiment of the magnetic tool suspension rack in accordance with the present invention, in this embodiment, the rack 10A includes a plate extending therefrom and there are multiple first slide structures 12 defined in one side of the plate 14 for slidably mounting more tool holders 30.

As described above, the magnetic tool suspension rack in accordance with the present invention includes the following advantages.
A. Simplified structure: the magnetic device 20/50 is limited in the groove 11 in the bottom of the rack 10 by the engager 22/52 extending from the magnetic device 20/50. Consequently, the magnetic tool suspension rack in accordance with the present invention provides no structure to prevent the magnetic device 20/50 from detaching from the rack 10.
B. Enhanced magnetic effect: the trough 23/53 has a depth greater than a thickness of the magnet 24/54 such that a height difference H is formed between the sidewall 231 of the trough 23 and the face of the magnet 24. The height difference H can prevent the magnet 24 from directly abutting to the adsorbate and enhancing the magnetic effect of the magnetic device 20/50.
C. Simplified manufacturing processes: the magnet 24/54 is directly positioned in the trough 23/53 because the seat 21/51 is made of magnetic induction material such that the magnetic tool suspension rack in accordance with the present invention needs no elements to hold the magnet 24/54 in place and the manufacturing processes of the present invention are simplified.
D. The magnet 24/54 in the seat 21/51 does not directly abut the adsorbate such that the magnet 24/54 is hard to be detached from the seat 51/51 due to the non-equivalence magnetic effect between the seat 21/51 and the adsorbate.

Although the invention has been explained in relation to its preferred embodiment, it is to be understood that many other possible modifications and variations can be made without departing from the spirit and scope of the invention as hereinafter claimed.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A magnetic tool suspension rack comprising:
a rack having a groove extending longitudinally at a bottom of said rack, said rack having sides extending downwardly, each of said sides having an inwardly turned bottom edge so as to define a slot opening to said groove;
a plurality of tool holders slidably mounted on a top of said rack, each of said plurality of tool holders adapted to receive a tool thereon; and
at least one magnetic device slidably received in said groove, the magnetic device adapted to position said rack on a metal cabinet, the magnetic device comprising:
a seat slidably received in said groove, said seat having a first engager extending outwardly from one side of said seat and a second engager extending outwardly of an opposite side of said seat, said first and second engagers respectively received in the slots of said rack so as to prevent said seat from detaching from said rack, said seat having a trough formed therein, said trough defined by the sides of said seat, each of said sides having a width dimension; and
a magnet magnetically secured in said trough of said seat, said magnet having a thickness dimension that is less than a width dimension of the side of said seat such that a bottom of said magnet is spaced inwardly from a plane extending across a bottom of the sides of said seat such that the bottom of said magnet is spaced from the metal cabinet when said magnetic device is positioned on a metal cabinet.

22. The magnetic tool suspension rack of claim 21, said first and second engagers are located at opposite ends of a diagonal extending from corners of said seat.
